(19) United States
(12) Patent Application Publication
(10) Pub. No.: US 2009/0019051 A1
(43) Pub. Date: Jan. 15, 2009

(54) UBIQUITOUS DOCUMENT ROUTING ENFORCEMENT

(75) Inventor: James Winburn, Creedmoor, NC (US)

Correspondence Address: SHERIDAN ROSS PC, 1560 BROADWAY, SUITE 1200, DENVER, CO, 80202, US

(73) Assignee: PHARMACEUTICAL PRODUCT DEVELOPMENT, LP, Wilmington, NC (US)

(21) Appl. No.: 12/171,778

(22) Filed: Jul. 11, 2008

Related U.S. Application Data
(60) Provisional application No. 60/949,117, filed on Jul. 11, 2007.
(60) Provisional application No. 60/970,383, filed on Oct. 5, 2007.

(51) Int. Cl. G06F 17/30

(52) U.S. Cl. 707/9; 707/E17.008

(57) ABSTRACT

Users can create document(s) in any format, and then submit these to a pre-processor. The pre-processor cooperates with the “save” function. The pre-processor associates, such as through embedding or adding a custom stream or modifying an existing custom stream within a compound document or association via file descriptors or file identifiers managed externally for any file type, record or object, a tag with the document preserving the original file format so that it can be rendered normally. A programmatically readable “label(es)” identifying a specific recipient identifier will be used for routing control identification. Document routing enforcement utilizes a form of the functionality of managing custom streams within compound documents or any file type, record or object. A compound document is a document consisting of intermingled multiple streams, e.g., metadata, spreadsheets, pictures, digital videos, digital audio, and other multimedia features and can also be used to collect several documents into one.

### RELATED APPLICATION DATA

This application claims the benefit of and priority under 35 U.S.C. § 119(e) to U.S. Patent Application Nos. 60/949,117, filed Jul. 11, 2007, entitled “UBIQUITOUS DOCUMENT ROUTING ENFORCEMENT,” and 60/970,383, filed Oct. 5, 2007, entitled “UBIQUITOUS DOCUMENT ROUTING ENFORCEMENT,” which are both incorporated herein by reference in their entirety.

### SUMMARY

An exemplary aspect of the invention relates to significantly increasing the probability that an electronic source file is delivered to an intended recipient across multiple transport options.

An exemplary aspect will work with any file format including unknown and future developed formats, including data, email, audio, video, multimedia, or in general, any file format or combination of file formats or in general any electronically stored information. Transports may include but not limited to, send mail and document file repositories or document sharing technologies.

Aspects of the invention relate to document management.

Further aspects of the invention relate to document management and dissemination control through the use of recipient identifiers and intelligent gateways.

Still further aspects of the invention relate to document tagging and analysis by a document management module.

Additional aspects of the invention relate to document tagging being used to restrict transport of one or more file to one or more destinations based on information in the tag.

Aspects also relate to providing an alert if a document tag does not match an intended recipient's authorized domain(s).

Aspects of the invention further relate to tagging a plurality of documents with a recipient identifier information in a batch process.

Aspects of the invention further relate to utilizing a command-line command to tag one or more documents.

Aspects of the invention further relate to tagging a plurality of files with a recipient identifier information in a batch process.

Aspects of the invention further relate to utilizing a command-line command to tag one or more files.

Aspects of the invention further relate to the use of a tag that can be independent of authorized domain information thereby allowing authorized domain information associated with a client to be changed without the need to update every document tag.

These and other needs are addressed by the various embodiments and configurations of the present invention.

The present invention can provide a number of advantages depending on the particular configuration. These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The exemplary embodiments of the invention will be described in detail, with reference to the following figures wherein:

FIG. 1 illustrates an exemplary method for document preprocessing according to this invention.

FIG. 2 illustrates an exemplary method for document routing enforcement in an FTP gateway environment according to this invention.

FIG. 3 illustrates an exemplary method for document routing enforcement in a document exchange gateway environment according to this invention.

FIG. 4 illustrates an exemplary method for document routing enforcement in an email gateway environment according to this invention.

FIG. 4 illustrates an exemplary document routing enforcement system according to this invention.

FIGS. 6-20 illustrate exemplary graphical user interfaces (GUIs) associated with an exemplary working embodiment of the invention.

FIG. 21 illustrates an exemplary tag according to this invention.

### DETAILED DESCRIPTION

The exemplary embodiments of this invention will be described in relation to document routing, management and handling. However, it should be appreciated, that in general, the systems and methods of this invention will work equally well for any type of document, file, electronic file or file format in any environment. As such, while the following discussion utilizes the term document to describe the various embodiments of the invention, it is to be appreciated that the term document can be interchanged with any of file, electronic file or file format. A document could also be casebooks, records or any general storage element that represents information.

The exemplary systems and methods of this invention will also be described in relation to document management. However, to avoid unnecessarily obscuring the present invention, the following description omits well-known structures and devices that may be shown in block diagram form or otherwise summarized.

For purposes of explanation, numerous details are set forth in order to provide a thorough understanding of the present invention. It should be appreciated however that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a telecommunications network and/or the Internet, or within a dedicated secure, unsecured and/or encrypted system. Thus, it should be appreciated that the components of the system can be combined into one or more devices, or collocated on a particular node of a distributed network, such as a communications network. As will be appreciated from the following description, and for reasons of computational efficiency, the components of the system can be arranged at any location within a distributed network without affecting the operation of the system. Similarly, one or more functional portions of the system could be distributed between a document management module and an associated computing device.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

Users can create document(s)/file(s) as normal in any format of their choosing, and then submit these to a pre-processor. The pre-processor can take form of a stand-alone device/ application or work in conjunction with, for example, the “save” and “save as” functions in the application used to create or edit the document. The pre-processor would associate, such as through embedding, association via file descriptors or file identifiers managed externally to the file, or adding a custom stream or modifying an existing custom stream within a compound document, a recipient identifier in the document preserving the original file format so that it can be rendered normally. The effect is a programmatically readable “label” or multiple labels identifying a specific recipient identifier that will be used for routing control identification.

The pre-processor module can take several possible forms. Below are a few exemplary options:
i. Option 1—(after document creation) a stand alone desktop application that will engage the user for the specific recipient name (organization name) and embed this as metadata in the file, or association via file descriptors or file identifiers managed externally to the file, which is then sent along with the original file to the transport.
ii. Option 2—(after document creation) an application, for example associated with a device such as a photocopier, that will engage the user for the recipient name (organization name) and embed this as metadata in the file, which is then sent along with the original file to the transport.

iii. Option 3—(before document creation) can be based on authorization access to a document template that is “pre-loaded” with specific recipient information from a controlled template structure.
iv. Option 4—(upon document creation) metadata (read/write) objects are called from within a software application, such as a Microsoft® Office® application, via an override function implemented via the save or save as event and labelling is entered at creation. The pre-processor could also be an application level add-in into the existing client application like Outlook® or a document upload/management tool instead of being a standalone application.

All transports activate specific objects to examine and match the recipient identifier to a database reference containing, for example, recipient name, organization name and domain information, specific recipient identifier and possibly a recipient specified identifier (The originator may have no knowledge of this identifier). In general it should be appreciated that the database can be configured to maintain any data or information which could aid in determining correct document routing.

The routing enforcement module, document routing module and gateway(s) will cooperate to automatically match the recipient identifier to a repository list or database of authorized domains.

If a match is verified, the document will be transported or stored for future access; if not, the user can receive a message, such as the indication of an error, and can one or more of:
i. be prevented from completing the transport,
ii. queried for updated information,
iii. allowed to override the determination by the routing enforcement module
iv. update information in the sponsor directory

The methodology and exemplary embodiments disclosed herein are agnostic to the technology utilized.

Document Routing Enforcement utilizes a form of the functionality of managing custom streams within compound documents or custom descriptors/identifiers for other document types. A compound document is a text document comprising intermingled multiple streams, e.g., metadata, spreadsheets, pictures, digital videos, digital audio, and other multimedia features. It can also be used to collect several documents into one.

Technologies for compound documents include:
Object linking and embedding (OLE) by Microsoft®
Bonobo by Ximian (primarily used by GNOME)
KParts in KDE
Verdantium
XML and XSL are encapsulation formats used for compound documents of all kinds
Adobe® XMP

Two exemplary possibilities are embedding metadata using an extensible metadata framework or encrypting a file specific hash with internal public/private keys managed within a central recipient database. In the latter case, the transport or gateway verifies authenticity by decrypting the hash of the file with the client specific private key.

The pre-processor provides an overview of possible directions for the design and implementation of the preprocessor component. One exemplary embodiment provides a framework that would satisfy the requirements of the component without committing to any one implementation. This approach allows for alternate implementations to be considered as needed.

For example, one exemplary purpose of the preprocessor module is to associate a file with a particular data item (i.e. the client name) that is later utilized by a separate component to provide some useful function (i.e. control of information distribution).

At a high level some of the aspects of one exemplary embodiment include:
1. Reuse of code: In one exemplary embodiment, each component can share code resources.
2. The preprocessor logic can be implemented without committing to an underlying process.
3. Deployment: Assuring that all components are “on the same page” regarding methodology. This may be accomplished through the use of a versioning scheme.
4. Timing: Depending on the methodology there may be subtle timing issues affecting the process. For example, with coherence between central and local database objects. Additionally, implementations that embed information within the file risk corruption of that data if the file is re-edited after preprocessing—this issue can be addressed by either re-associating the tag information or, for example, making a back-up of the tag prior to editing and then re-associating the tag after editing.
5. User experience: In the long term, ease of use will likely become increasingly important. The exemplary embodiments attempt to reduce user burden.

Possible methods of tagging the file include:
1. Embedding data within the file.
2. Embedding the data within a separate file associated (by some means) with the original file.
3. Associating the filename with the data. This could optionally be done by updating a central repository.
4. Via email attachments.
5. Metadata, or the like.

Note that there are many divergent potential methods of associating the data with the file. One design focus of the preprocessor is to attempt to support any method.

In one example, the preprocessor exists as a desktop application which can be used to “tag” files with client information. The “normal” mode of use would be to drag a file onto the application icon, initiating a simple dialog which would allow the user to select a client (or perhaps clients) from a list and somehow tagging the file with this data.

The exemplary logic is:
1. Detect the path to the file.
2. Validate the file.
3. Tag the file.—This is the part that is kept general and would be handled by a subclass of the (so called) CTagFileDialog class.
4. Exit the program.

Additionally, it might optionally be desirable to provide some administrative functionality. This functionality could be provided by simply double-clicking the application at which point you would have access to the menus which could provide a simple File Menu Open item to perform the “normal” tagging operation, and another menu item to authenticate the user and provide some administrative capabilities. These might include updating the version information or simple database maintenance.

CTagFileDialog:

Below is an exemplary interface for the CTagFileDialog class. It is responsible for doing something with the file that means something.

A CTagFileDialog class follows:

#include <vector>
#include <string>
#include “PreProcess.h”
using namespace std;
#define STRINGLISTvector<std::string>

| | |
|---|---|
| #define TAGINFO | void * |
| #define TAGVERSION | long |

```
// this is the base class
// ... it is an interface to support use in a dll scenario
class CTagFileDialogBase
{
public:
  CTagFileDialogBase(char *filePath, HINSTANCE instance, HWND
  mainWnd)
  {
    m_filePath = filePath;
    m_instance = instance;
    m_mainWnd = mainWnd;
  }
  virtual ~CTagFileDialogBase( ) { }
  // function for tagging the file
```

| | |
|---|---|
| virtual bool | DoDialog( ) = 0; |

// function for getting the tag information

| | |
|---|---|
| virtual void | GetTagInfo(TAGINFO &tagInfo) = 0; |

```
  // return the version
  virtual TAGVERSION  GetVersion( ) = 0;
private:
```

| | |
|---|---|
| char * | m_filePath; |
| HINSTANCE | m_instance; |

| | |
|---|---|
| HWND | m_mainWnd; |

```
};
// this is the version that uses the public private key mechanism
class CTagFileWithKeyDialog : CTagFileDialogBase
{
public:
static TAGVERSION cVersion = 0x10000; // this has to be unique
  CTagFileWithKeyDialog(char *filePath, HINSTANCE instance,
  HWND mainWnd);
  virtual ~CTagFileWithKeyDialog( );
  // function for tagging the file
```

| | |
|---|---|
| virtual bool | DoDialog( ); |

// function for getting the tag information

| | |
|---|---|
| virtual void | GetTagInfo(TAGINFO &tagInfo); |

```
  // return the version
  virtual TAGVERSION  GetVersion( )
  {
    return CTagFileWithKeyDialog::cVersion;
  }
private:
```

| | |
|---|---|
| INT_PTR | m_ResID; |

STRINGLIST m_ClientList;
};

Using this method, the preprocessor code may not need to change to support alternate tagging methods—And the versioning information can be used to validate tag information and tagging code.

Pre-Processor Code Example:

The following example illustrates how a customer id based on a private/public key pair could be managed.

```
//This class serves as a mail client that gets all information pertaining to a mail, creates an
//encrypted hash of any attachment and sends the email
public partial class _Default : System.Web.UI.Page
{
  protected bool CheckFileUpload( )
  {
    Boolean fileOK = false;
    if (IsPostBack)
    {
      String path = Server.MapPath(“~/Test/”);
      if (fup.HasFile)
      {
        String fileExtension =
          System.IO.Path.GetExtension(fup.FileName).ToLower( );
        String[ ] allowedExtensions =
        { “.gif”, “.jpeg”, “.jpg”, “.doc”, “.pdf”, “.txt”, “.rtf” };
        for (int i = 0; i < allowedExtensions.Length; i++)
        {
          if (fileExtension == allowedExtensions[i])
          {
            fileOK = true;
          }
        }
      }
    }
    return fileOK;
  }
  protected void bSubmit_Click(object sender, EventArgs e)
  {
    MailMessage MM = new MailMessage(strFrom, strTo, strSubject, txtMsg.Text);
    //Attach files
    if ( fup != null )
    {
      if (CheckFileUpload( ))
      {
        //file uploaded successfully
        //compute hash and encrypt hash
        string secError = “”;
        byte[ ] DatatoEncrypt = fup.FileBytes;
        byte[ ] EncryptedData = SecureAttach.SecureAttachTest(DatatoEncrypt, ref
secError);
        if (secError.Length > 0) //error occured
        {
          lblStatus.Text = secError;
        }
        else
        {
          //Encryption successful, can proceed with sending email
          //save encrypted bytes to a temp file
          String path = Server.MapPath(“~/Test/”) + fup.FileName + “.enc”;
          FileStream fdest = File.Create(path);
          for (int i = 0; i < EncryptedData.Length; i++)
          {
            fdest.WriteByte(EncryptedData[i]);
          }
          //send original attachment
          Attachment attach1 = new Attachment(fup.PostedFile.InputStream,
fup.FileName, MediaTypeNames.Application.Octet);
          MM.Attachments.Add(attach1);
          //send encrypted data
          Attachment attach2 = new Attachment(fdest,fup.FileName + “.enc”,
MediaTypeNames.Application.Octet);
          MM.Attachments.Add(attach2);
        }
      }
    }
    SmtpClient SC = new SmtpClient( );
    SC.Send(MM);
    Response.Write(“Email was queued to disk”);
  }
}
//This is the helper class that creates a hash of a file and encrypts the hash
using System;
using System.Data;
using System.Configuration;
using System.Web;
using System.Web.Security;
using System.Web.UI;
using System.Web.UI.WebControls;
using System.Web.UI.WebControls.WebParts;
using System.Web.UI.HtmlControls;
using System.Security.Cryptography;
using System.Text;
using System.IO;
/// <summary>
/// Summary description for SecureAttach
/// </summary>
public class SecureAttach
{
        private string _SourceFilepath;
  RSAParameters _PublicKey;
  RSAParameters _PrivateKey;
  public SecureAttach( )
  {
    RSACryptoServiceProvider rsa = new RSACryptoServiceProvider( );
    _PublicKey = rsa.ExportParameters(false);
    _PrivateKey = rsa.ExportParameters(true);
  }
  public SecureAttach(string SourceFilepath)
        {
          _SourceFilepath = SourceFilepath;
        }
        public string SourceFile
        {
          get
          {
            return _SourceFilepath;
          }
          set
          {
            _SourceFilepath = value;
          }
        }
  public RSAParameters PublicKey
  {
    get
    {
      return _PublicKey;
    }
    set
    {
      _PublicKey = value;
    }
  }
  public RSAParameters PrivateKey
  {
    get
    {
      return _PrivateKey;
    }
    set
    {
      _PrivateKey = value;
    }
  }
  public byte[ ] RSAEncrypt(byte[ ] DataToEncrypt, RSAParameters RSAKeyInfo, bool
DoOAEPPadding)
  {
    try
    {
      //Create a new instance of RSACryptoServiceProvider.
      RSACryptoServiceProvider RSA = new RSACryptoServiceProvider( );
      //Import the RSA Key information. This only needs
      //toinclude the public key information.
      RSA.ImportParameters(RSAKeyInfo);
      //Encrypt the passed byte array and specify OAEP padding.
      //OAEP padding is only available on Microsoft Windows XP or
      //later.
      return RSA.Encrypt(DataToEncrypt, DoOAEPPadding);
    }
    //Catch and display a CryptographicException
    //to the console.
    catch (CryptographicException e)
    {
      Console.WriteLine(e.Message);
      return null;
    }
  }
  public byte[ ] RSADecrypt(byte[ ] DataToDecrypt, RSAParameters RSAKeyInfo, bool
DoOAEPPadding)
  {
    try
    {
      //Create a new instance of RSACryptoServiceProvider.
      RSACryptoServiceProvider RSA = new RSACryptoServiceProvider( );
      //Import the RSA Key information. This needs
      //to include the private key information.
      RSA.ImportParameters(RSAKeyInfo);
      //Decrypt the passed byte array and specify OAEP padding.
      //OAEP padding is only available on Microsoft Windows XP or
      //later.
      return RSA.Decrypt(DataToDecrypt, DoOAEPPadding);
    }
    //Catch and display a CryptographicException
    //to the console.
    catch (CryptographicException e)
    {
      Console.WriteLine(e.ToString( ));
      return null;
    }
  }
  //Simple Hashing
  public byte[ ] HashFile(byte[ ] ToHash)
  {
    byte[ ] hashbyte = { };
    try
    {
      //Open the Source file
      //FileStream fsSource = File.OpenRead(_SourceFilepath);
      //Create the default hash algorithm
      HashAlgorithm hash = HashAlgorithm.Create( );
      //Compute the hash
      hashbyte = hash.ComputeHash(ToHash);
      //close the streams
      //fsSource.Close( );
    }
    catch (Exception)
    {
    }
    return hashbyte;
  }
  public static byte[ ] SecureAttachTest(byte[ ] FileBytes, ref string error)
  {
    //string file;
    byte[ ] SignedHash = null;
    try
    {
      SecureAttach sh = new SecureAttach( );
      byte[ ] hashbytes = sh.HashFile(FileBytes);
      if (hashbytes.Length == 0)
      {
        error = “Failed to hash the file”;
        return SignedHash;
      }
      //Create signature of hash with public key
      SignedHash = sh.RSAEncrypt(hashbytes, sh.PublicKey, false);
      if (SignedHash.Length == 0)
      {
        error =“Failed to encrypt hash”;
        return SignedHash;
      }
      //error = “Encrypted hash successfully”;
      return SignedHash;
    }
    catch (Exception ex)
    {
      error = ex.Message;
      return SignedHash;
    }
  }
    }
```

TagReadWriteClass:

This exemplary technology can encapsulate the Read/Write functionality in a portable object technology that can be scripted via any gateway scripting tool capable of instantiating an object.

The exemplary scripting could:
1. be invoked on an event associated with a gateway. (e.g., “send” in email or drag drop on a specific gateway.)
2. extract the tag (specific recipient identifier) and compare it to domains approved and related to “Customer”
3. If a match occurs; the requested action is completed and the event optionally recorded for audit.
4. If not, the user (initiator) will be notified and the event recorded for audit.

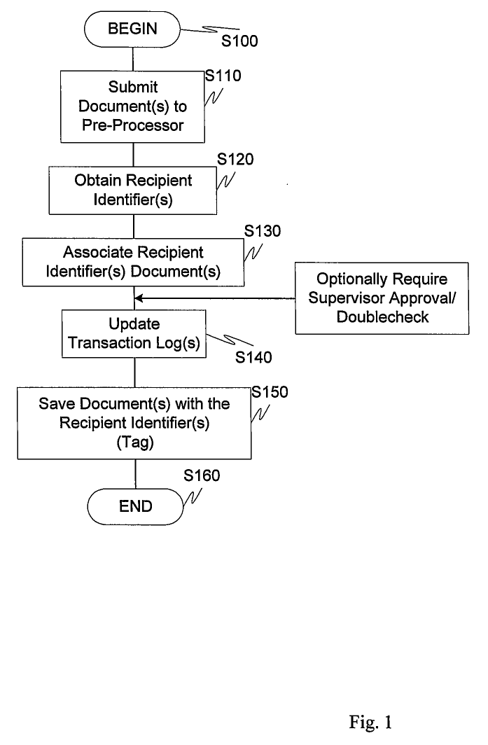

FIG. 1 illustrates an exemplary methodology for tagging a document, file, or in general, any information. In particular, control begins in 100 and continues to S110. In step S110, the information (e.g., file, document, electronic information, etc.), which will generally be referred to as a document, is submitted to a pre-processor. Next, in step S120, one or more recipient identifiers are obtained. For example, these recipient identifiers can be obtained via user input, based on a pre-defined template, or with the cooperation of an intelligent agent that, for example, parses one or more of header information, address information and the contents of the document and based thereon is able to identify one or more recipient identifiers. Then, in step S130, the recipient identifiers are associated with the document. Optionally, to add another layer of security to the system, the associated recipient identifiers can be verified by, for example, a supervisor to assist with integrity of the system. Control then continues to step S140.

In step S140, one or more transaction logs are optionally updated encapsulating all or a portion of the above steps. Next, in step S150, the document is saved with the recipient identifier, i.e., tag.

As discussed herein, this tag need not necessarily be embedded in a document, but can be associated with the document(s) and stored in, for example, a separate tag database that includes information as to which one or more documents the particular tag is associated with. Control then continues to step S160 where the control sequence ends.

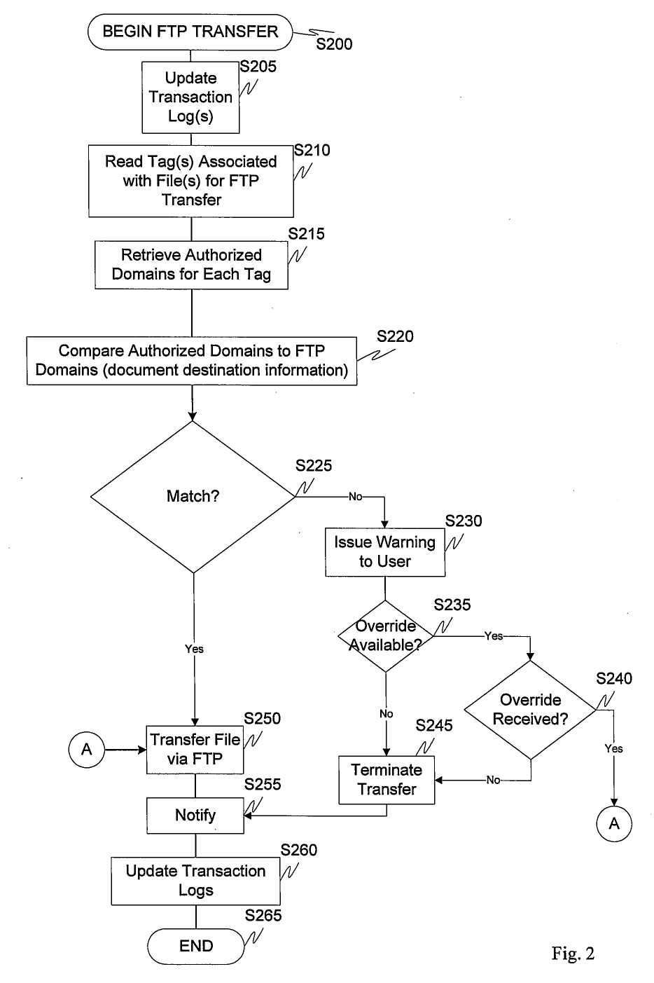

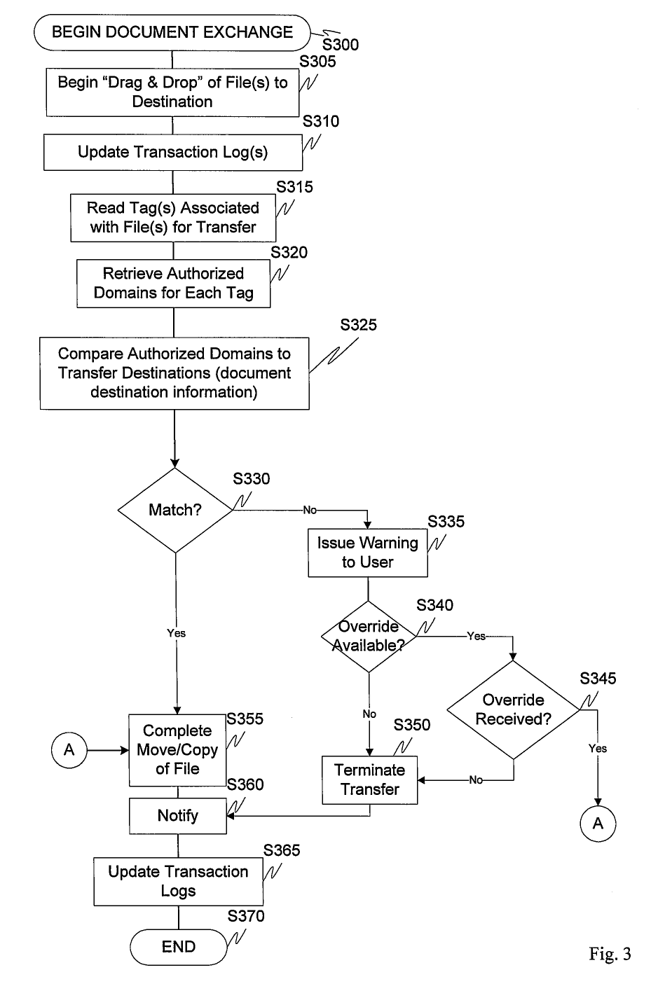

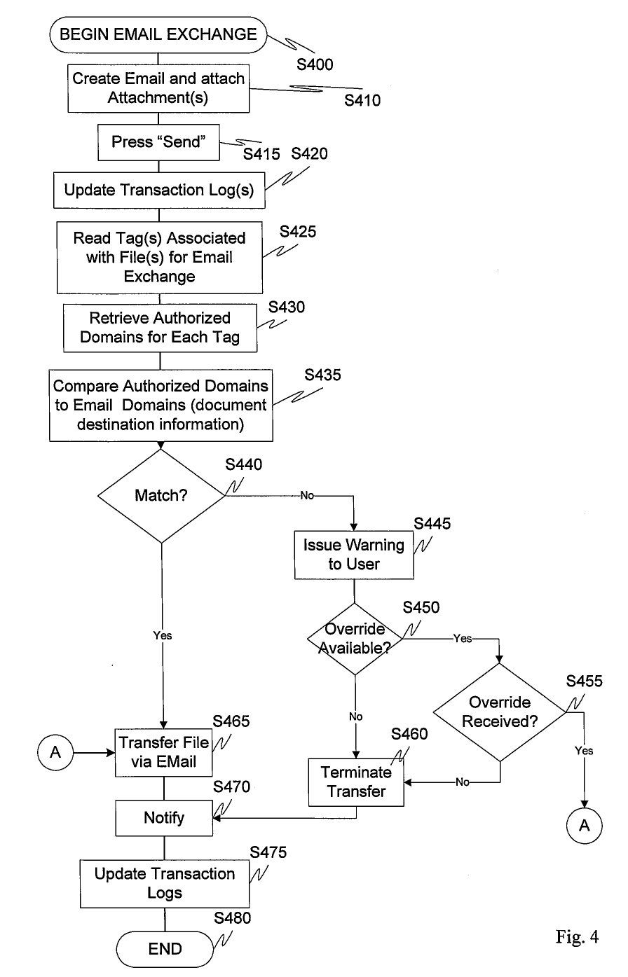

FIGS. 2-4 illustrate exemplary methodologies where the document is being transmitted via a specific gateway. More specifically, FIG. 2 illustrates a methodology where the document is being transported via an FTP transfer, FIG. 3 illustrates an embodiment where a document exchange, such as a “drag and drop” or copy/move of a document to a destination is occurring, and FIG. 4 illustrates an embodiment where the document is being transferred via e-mail.

For the exemplary FTP transfer methodology illustrated in FIG. 2, control begins in step S200 and continues to S205. In step S205, the transaction logs are optionally updated. Next, in step S210, one or more tags associated with the files that are scheduled for FTP transfer are read. Then, in step S215, the authorized domains for each tag are retrieved. Control then continues to step S220.

In step S220, the authorized domains for each tag are compared to the destination FTP domains. Next, in step S225, a determination is made whether there is a match. If there is a match, control continues to step S250, with control otherwise jumping to step S230. In step S230, a warning is optionally issued to the user. This warning can be graphical and/or audible and can be displayed in conjunction with the application in use or be in its own separate, for example, pop-up window. Next, in step S235, a determination is made whether an override is available. If an override is available, control continues to step S240. Otherwise, control jumps to step S245.

In step S240, a determination is made whether an override has been received. If an override has been received, control jumps to step S250. Otherwise, control continues to step S245.

In step S245, transfer is terminated with control continuing to step S255.

In step S250, the file is transferred via FTP. Next, S255, the user is notified that the transaction has been completed, and in step 260, the transaction logs are updated with control ending in step S265.

FIG. 3 outlines an exemplary embodiment where, for example, a file is copied from a first location to a second location. In particular, control begins in step S300 and continues to step S305. In step S305, the file(s)/document(s) is requested to be copied to a destination. Next, in step S3 10, the transaction logs are optionally updated, then, in step S3 15, the tags associated with the files for transfer are read. Control then continues to step S320.

In step S320, the authorized domains for each tag associated with the files are retrieved. Next, in step S325, the authorized domains are compared to the transfer destinations for the files.

In, step S330, a determination is made whether the authorized domains in the requested transfer destinations match. If there is a match, control continues to step S335. Otherwise, control jumps to step S335.

In step S335, a warning is issued to the user. Next, in step S340 a determination is made whether an override is available. If an override is available, control continues to step S345 where a determination is made whether an override is received. If an override is received, control jumps to step S355. Otherwise, control continues to S350 where the transfer is terminated. Control then continues back to step S360.

In step S355, and providing there is a match, the move and/or copy of the file is completed.

Next, in step S360, the user is notified based on which action is completed. Then, in step S365, the transaction logs are updated with control continuing to step S370 where the control sequence ends.

FIG. 4 illustrates an exemplary embodiment where one or more documents, such as attachments, are exchanged via e-mail. In particular, control begins in step S400 and continues to step S4 10. In step S4 10, e-mail is generated and one or more attachments associated therewith. Next, in step S415, and optionally in conjunction with the pressing of the “send” button, the transaction logs are updated in step S420 and one or more tags associated with the files for e-mail exchange are read. Then, in step S430, the authorized domains for each tag are retrieved. Control then continues to step S435.

In step S435, the authorized domains are compared to the domains associated with the to-be-sent e-mail. In step S440, a determination is made whether there is a match. If there is a match, control jumps to step S465. Otherwise, control continues to step S445 where a warning is issued to the user.

As with the other embodiments, in response to the warning to the user, the user can one or more of edit the recipients of the e-mail, modify the tags association with the attachments or obtain an override, such as in step S450. If an override is available, control continues to step S455 where if an override is received, control jumps back to S465. Otherwise, control continues to step S460 where the sending of the e-mail is terminated. Control then continues back to step S470.

For an override, for example, the tag could optionally include information indicating who, if anyone, is authorized to provide an override. Absent authorization from one of the specified authorized entities, the transaction is not allowed to be completed.

In step S465, the e-mail is sent with the associated attachment. Next, step S470, the user can optionally be notified of either the completion of the e-mail transfer or the termination of the transfer. Similarly, and depending on the type of action, one or more of a user, supervisor or other entity(s) can be notified about the transaction. For example, if the transfer was terminated, a supervisor could be notified that the transaction was terminated and details thereof provided thereto. Likewise, notification and details of a successful transfer can be reported to one or more entities and optionally a record created confirming the transfer was to an authorized domain(s).

In step S475, the transaction logs are optionally updated with control ending in step S480.

FIG. 5 illustrates an exemplary document management system 1 according to this invention. The document management system 1 comprises a routing enforcement module 510, a pre-processor 520, a document routing module 530, an I/O interface 540, a recipient directory 550, with an associated database 560, a transaction log 570, controller 580 and memory 590. The document management system 1 receives one or more of documents and files 515 and is connected to one or more gateways 505 via links 5 and networks 10.

In operation, one or more of a document and file 515 is forwarded to the routing enforcement module 510. For example, and as previously discussed, upon selecting the “send” button in an e-mail type environment, on completion of a drag and drop in a copy type environment, or upon selecting “transfer” in an FTP type environment, the document management system functionality is invoked. For example, this functionality could be invoked with the cooperation of an API or similar code type. Is should be appreciated however that the document management system functionality need not be limited to these particular invocation techniques, but could also be manually selected to pre-check a document to facilitate correct document routing. This pre-checking can be performed anytime a document tag and destination information are present.

Once the document 515 is submitted to the document management system 1, the routing enforcement module 510, in cooperation with the pre-processor 520, receives one or more recipient identifiers associated with the document. These recipient identifiers can be selected, for example, from a drop down list or otherwise selected. The recipient identifiers can be stored in a database and be associated with, for example, the specific client. It should be appreciated that the recipient identifiers can be edited, for example, to allow flexibility should, for example, a client move, change their domain name, installed a new FTP server, or in general be modified to reflect any information with one or more domains with which the client is associated. The domains can be associated with any one or more of an individual, a company(s), group of individuals, or in general, any person, entity, group, or sub-group as desired.

Once the one or more recipient identifiers are selected, they are associated with the document and stored, for example, in cooperation with the controller 580, memory 590, and I/O interface 540.

Next, and in cooperation with the document routing module 530, recipient directory 550, database 560, controller 580 and memory 590, the document is queued for transfer and the tag(s) association with the document read. Next, the tag(s) are correlated to one or more authorized domains associated with that tag, and a comparison performed to determine whether the routing information in the document corresponds to the authorized domains. If there is a match, transfer of the file is allowed to occur. However, if a match does not occur, one or more of a warning issued to the user, an override entered and transfer termination occur. In conjunction with one or more of these, a notification can also be sent to one or more entities, including the user, indicating that a document transfer was requested for which the authorized domains and the recipient information did not match. This can optionally be logged in a transaction log 570.

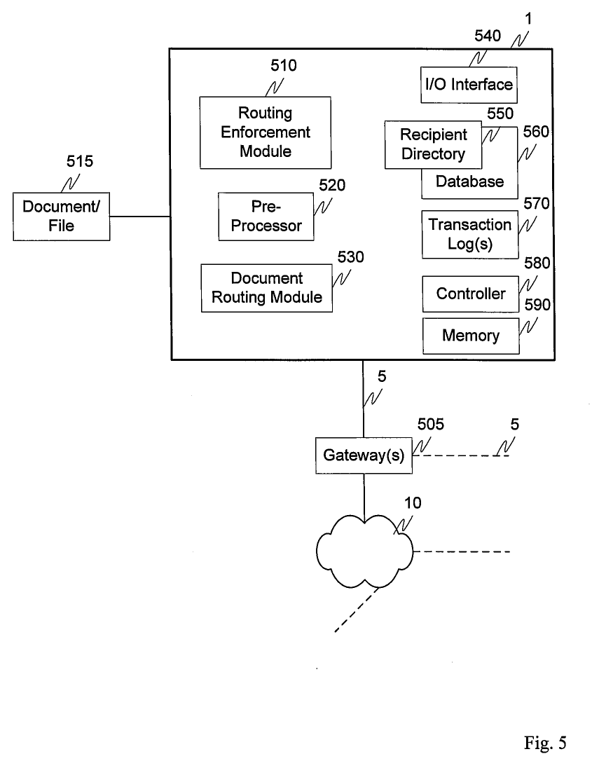

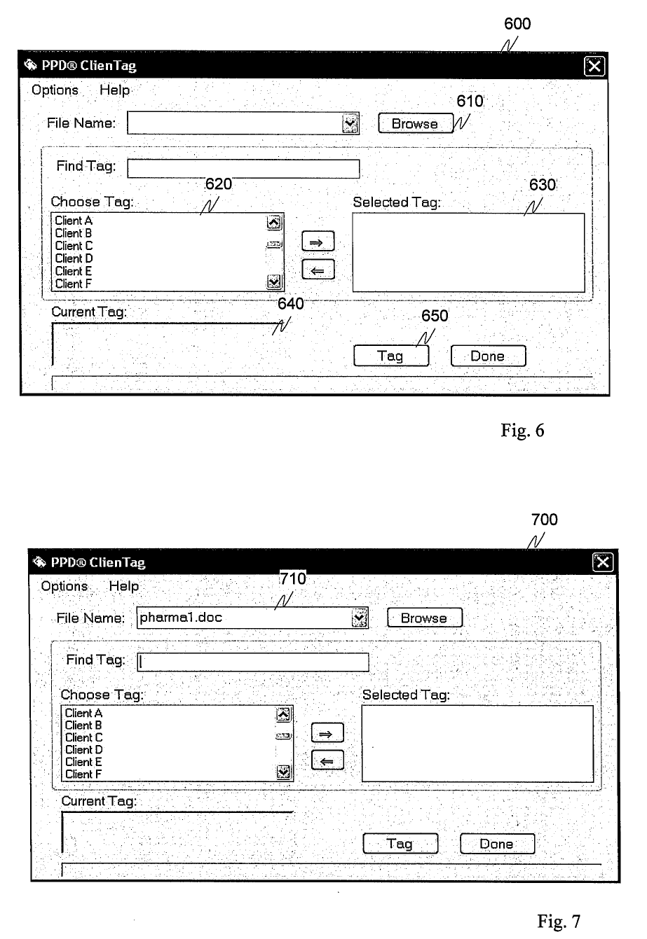

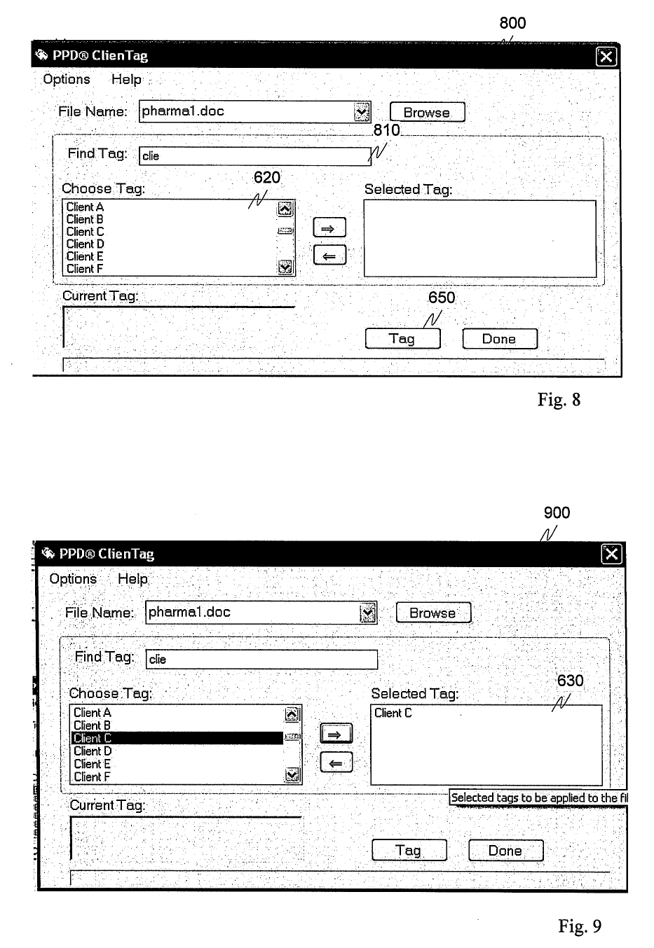

FIGS. 6-20 illustrate exemplary graphical user interfaces (GUI's) that can be used in conjunction with the functionality described herein. For example, FIG. 6 illustrates an exemplary user interface 600 that allows one or more tags to be associated with a document. In particular, the user selects the browse button 610 to select a document for which a tag is to be associated. Next, one or more tags are selected from the available tag portion 620 with the selected tags being identified in the selected tag portion 630. Additionally, if one or more tags are already associated with the document, those tags can be read and displayed in the current tag portion 640. Upon modifying and/or selecting the tags that are to be associated with the document, a user selects the tag button 650 to complete the association process.

FIG. 7 illustrates the selection of a document with the document name being displayed in the file name portion 710. Then, in GUI 800 illustrated in FIG. 8, a user can, for example, start typing the name of a particular tag with the available tag portion 620 filtering the available tags based on the information in the find tag field 810.

In interface 900, “Client C” has been chosen as a tag associated with “pharma1.doc” which is then shown in the selected tag portion 630.

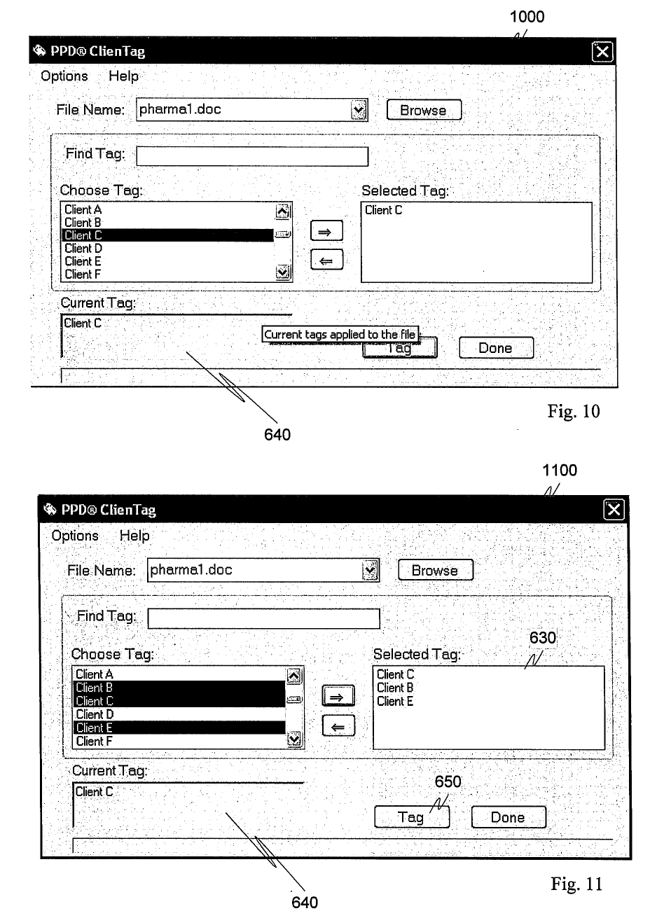

Interface 1000, shown in FIG. 10, illustrates in the current tag portion 640 that tag “Client C” has been previously associated with the file “pharma1.doc.” Interface 1100 illustrates that multiple tags can simultaneously be selected and associated with the document through the selection of the tag button 650.

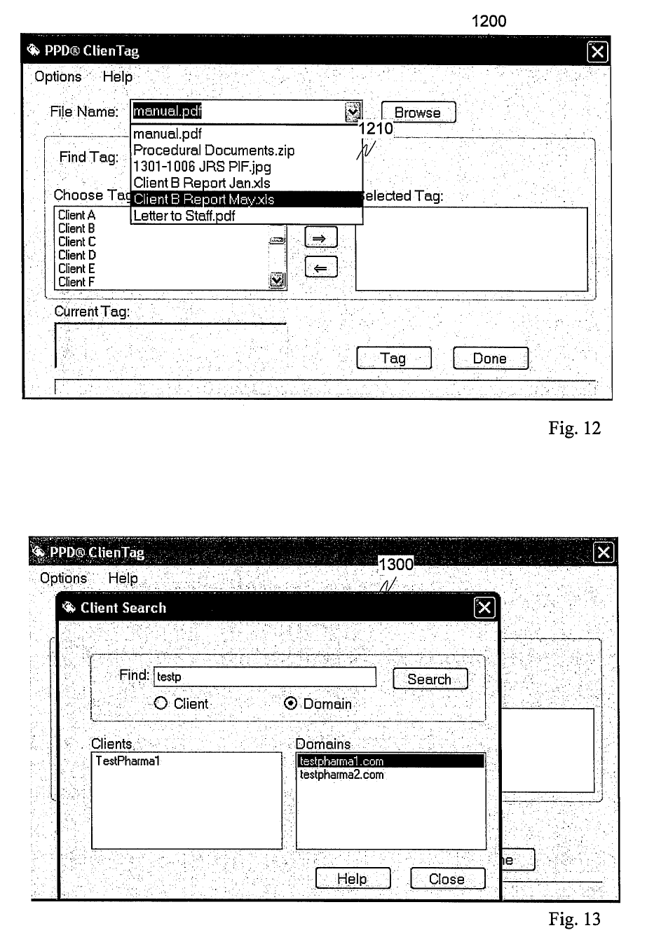

FIG. 12 illustrates an exemplary interface where the file name drop down menu 1210 provides a list of recently tagged documents.

FIG. 13 illustrates and exemplary client search interface 1300 that allows a user to, for example, search on one or more of a client and domain to assist with the tagging process.

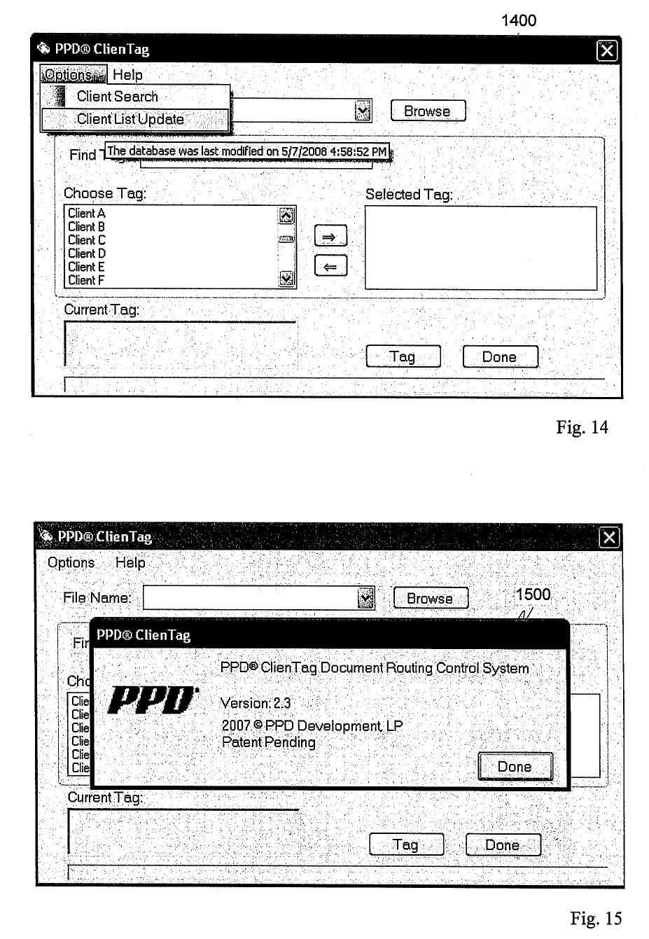

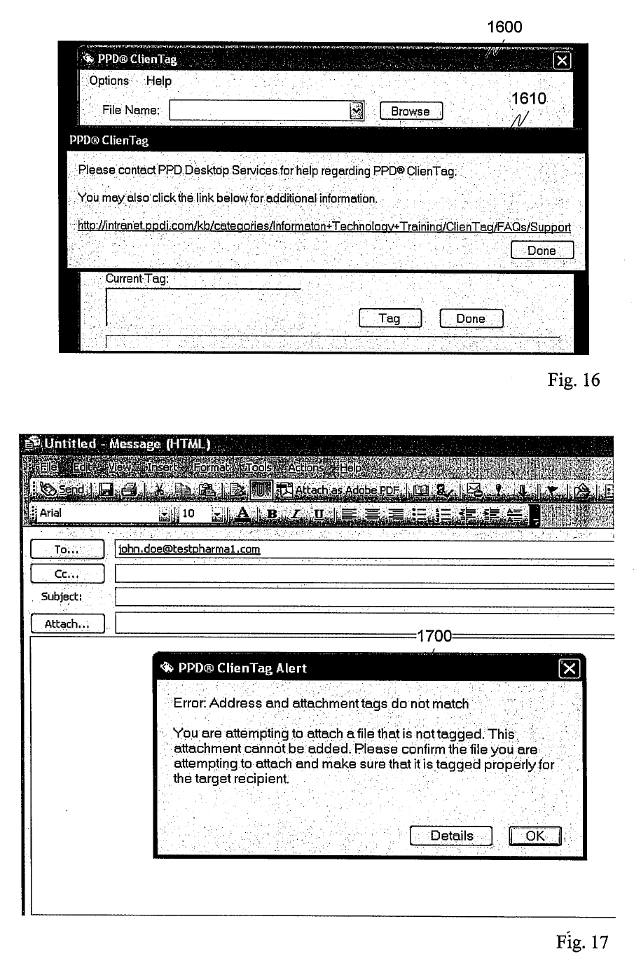

FIG. 14 illustrates a user interface that provides information about the version information of the database with FIG. 15 illustrating version information for the overall system in interface 1500. FIG. 16 illustrates an exemplary help screen that can be displayed upon selection of the help icon 1610.

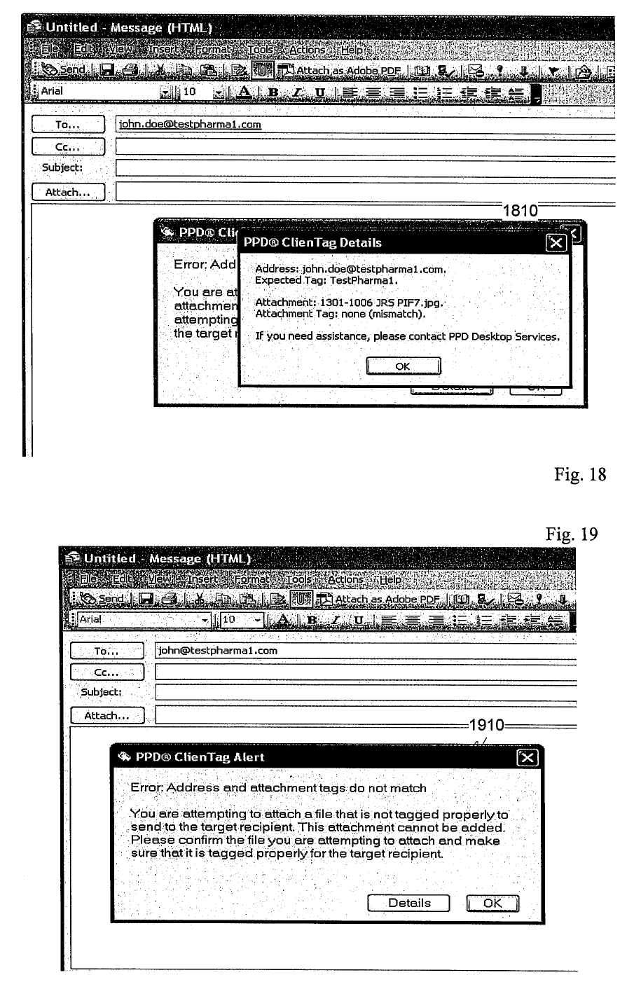

FIGS. 17-20 illustrate exemplary error messages that can be displayed to a user that correspond to various errors. For example, the error message in FIG. 17 indicates that the user is attempting to attach a file that is not tagged. In FIG. 18, an error is provided in interface 1810 indicating that there is no tag association with the attachment and provides the user an indication as to which tag was expected based, for example, on the entered e-mail address.

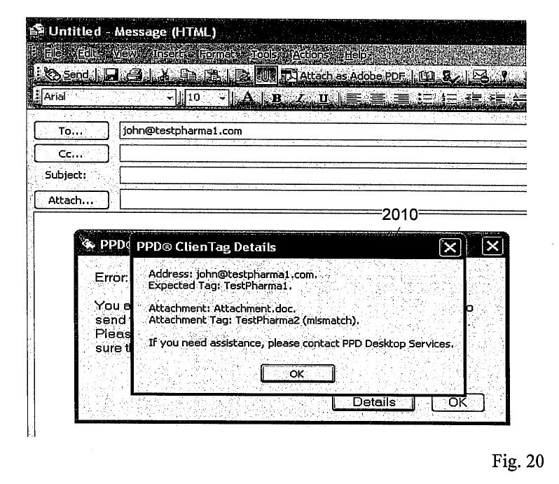

In FIG. 19, an interface 1910 is provided that indicates the email address and the attachment tags do not match. In FIG. 20, an interface 2010 is provided that displays to the user that a mismatch between the attachment tag and the address has been detected at which point the user can one or more of, update the tag association with the attachment, modify the address of the recipient, or both.

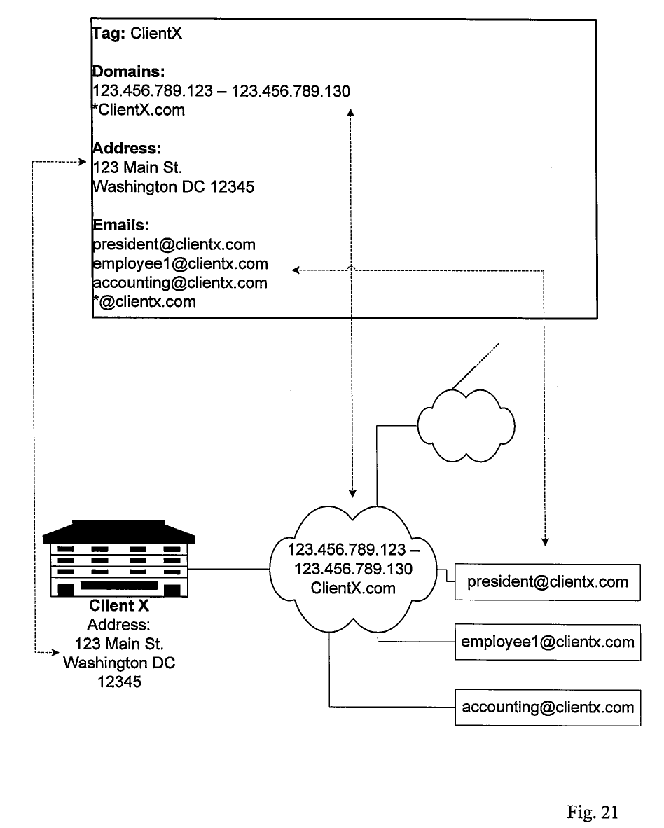

FIG. 21 illustrates the content of an exemplary tag and the correlation of the content in the tag to “Client X.” The content in the tag reflects domain information about Client X as illustrated with the dashed lines. Specifically, for Client X, the domain information in the tag represents the internet domains and IP addresses that are valid for Client X. The address information in the tag corresponds to the physical address of Client X and the email information in the tag corresponds to the valid email address for Client X.

If a user desires to transfer a file to Client X as an attachment to an email, then the address(es) in the email must match one or more of the valid addresses listed in the tag. In a similar manner, for an FTP transfer, the IP address of the ftp domain must match the information in the tag, e.g., ftp://ftp:clientx.com or ftp://123.456.789.123.

For a letter, the address in the letter must match the street address in the tag. It should be appreciated that any level of granularity can applied to the information in the tag about the “client” and sub-domains established that restrict, for example, sensitive information from being sent to anyone but the president of Client X.

While the above-described flowcharts have been discussed in relation to a particular sequence of events, it should be appreciated that changes to this sequence can occur without materially effecting the operation of the invention.

Additionally, the exemplary techniques illustrated herein are not limited to the specifically illustrated embodiments but can also be utilized with the other exemplary embodiments and each described feature is individually and separately claimable.

The systems, methods and techniques of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software (which can be stored on an information storage media) using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer arts.

Moreover, the disclosed methods may be readily implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an API, plug-in, applet, JAVA® or CGI script, as a resource residing on a server or computer workstation, as a routine embedded in a dedicated system or system component, or the like. The system can also be implemented by physically incorporating the system and/or method into a software and/or hardware system, such as the hardware and software systems of a computer.

It is therefore apparent that there has been provided, in accordance with the present invention, systems and methods for managing documents. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A document dissemination control system comprising:
a tag associated with one or more documents, the tag identifying authorized domain information;
a routing enforcement module adapted to read the tag and compare the authorized domain information with document destination information; and
a document routing module adapted to perform one or more of allowing the document to be transferred in accordance with the document destination information and blocking transfer of the document should the authorized domain information not correspond to the document destination information.

2. The system of claim 1, further comprising a pre-processor adapted to associate a recipient identifier with a document, the recipient identifier being included in the tag.

3. The system of claim 1, further comprising a transaction log adapted to track the transfer of the one or more documents.

4. The system of claim 1, wherein the document is one or more of a file, electronic file, compound document or file in a specific format.

5. The system of claim 1, further comprising a recipient directory maintaining tag information and the authorized domain information.

6. The system of claim 1, wherein the document routing module performs the allowing or blocking functionality before the document is forwarded to a gateway.

7. The system of claim 1, wherein a notification is generated and forwarded to one or more destinations if it is determined to block transfer of the document.

8. The system of claim 1, wherein the transfer is via one or more of an FTP gateway, email gateway, file transfer protocol and a document exchange procedure.

9. The system of claim 1, wherein the blocking of the transfer can be overridden.

10. The system of claim 1, wherein the document destination information or target directory structure is one or more of an IP address, an email address, a domain, a sub-domain and a physical address.

11. A document dissemination control method comprising:
associating a tag with one or more documents, the tag identifying authorized domain information;
reading the tag and comparing the authorized domain information with document destination information; and
performing one or more of allowing the document to be transferred in accordance with the document destination information and blocking transfer of the document should the authorized domain information not correspond to the document destination information.

12. The method of claim 11, further comprising a pre-processor adapted to associate a recipient identifier with a document, the recipient identifier being included in the tag.

13. The method of claim 11, further comprising tracking the transfer of the one or more documents.

14. The method of claim 11, wherein the document is one or more of a file, electronic file, compound document or file in a specific format.

15. The method of claim 11, further comprising maintaining tag information and the authorized domain information.

16. The method of claim 11, wherein the document routing module performs the allowing or blocking functionality before the document is forwarded to a gateway.

17. The method of claim 11, wherein a notification is generated and forwarded to one or more destinations if it is determined to block transfer of the document.

18. The method of claim 11, wherein the transfer is via one or more of an FTP gateway, email gateway, file transfer protocol and a document exchange procedure.

19. The method of claim 11, wherein the blocking of the transfer can be overridden.

20. The method of claim 11, wherein the document destination information is one or more of an IP address, an email address, a domain, a sub-domain and a physical address.

21. A document dissemination control system comprising:
means for associating a tag with one or more documents, the tag identifying authorized domain information;
means for reading the tag and comparing the authorized domain information with document destination information; and
means for performing one or more of allowing the document to be transferred in accordance with the document destination information and blocking transfer of the document should the authorized domain information not correspond to the document destination information.

22. An information storage media having stored thereon instructions that when executed control document dissemination comprising:
instructions that associate a tag with one or more documents, the tag. identifying authorized domain information;
instructions that read the tag and compare the authorized domain information with document destination information; and
instructions that perform one or more of allowing the document to be transferred in accordance with the document destination information and blocking transfer of the document should the authorized domain information not correspond to the document destination information.
